(19) United States
(12) Patent Application Publication
(10) Pub. No.: US 2025/0252539 A1
(43) Pub. Date: Aug. 7, 2025

(54) Material Classification with Conditional Diffusion Models

(71) Applicant: Google LLC, Mountain View, CA (US)

(72) Inventors: Yaojie Liu, Mountain View, CA (US); Wen-Sheng Chu, San Jose, CA (US); Manli Shu, San Jose, CA (US)

(21) Appl. No.: 19/044,049

(22) Filed: Feb. 3, 2025

Related U.S. Application Data
(60) Provisional application No. 63/549,265, filed on Feb. 2, 2024.

(51) Int. Cl. G06T 5/60; G06T 5/70; G06T 7/00; G06T 11/00; G06V 10/764; G06V 10/774

(52) U.S. Cl. CPC G06T 5/60; G06T 5/70; G06T 7/0002; G06T 11/00; G06V 10/764; G06V 10/774; G06T 2207/20081; G06T 2207/20084

(57) ABSTRACT

Provided are systems and methods that perform material classification of imagery using generative denoising diffusion models. Traditional material classification systems, which are predominantly based on discriminative models, face issues with generalization and diversity, particularly when encountering new or complex material compositions. Furthermore, these systems often function like black boxes, making it difficult to understand their decision-making processes or identify spurious correlations. The provided systems and methods address these challenges by leveraging the capabilities of diffusion models, which can provide better generalization and more transparent decision-making processes.

### RELATED APPLICATIONS

This application claims priority to and the benefit of U.S. Provisional Patent Application No. 63/549,265, filed Feb. 2, 2024. U.S. Provisional Patent Application No. 63/549,265 is hereby incorporated by reference in its entirety.

### FIELD

The present disclosure relates generally to machine learning models. More particularly, the present disclosure relates to performing material classification for imagery using generative denoising diffusion models.

### BACKGROUND

Material classification includes the process of identifying and categorizing different materials within an image, which can be critical for various applications such as recycling, quality control in manufacturing, and content-based image retrieval. Accurate material classification is essential for various downstream systems, operations, and/or tasks which depend upon or otherwise operate on the basis of a material classification generated by a material classification system.

Traditional material classification systems often rely on discriminative models that analyze textural, color, and/or spectral features to predict the type of material present in an image. These systems can struggle with the variability and diversity of materials, particularly when encountering new or complex material compositions. Moreover, the decision-making process of these discriminative models can be opaque, limiting their reliability and the users' trust in automated classification systems.

Another significant technical challenge in material classification is the limited availability of high-quality training data representing a wide variety of materials under different conditions. The scarcity of such data can lead to overfitting of the models, negatively affecting their ability to generalize to new types of materials or those captured under different circumstances. Collecting a comprehensive set of material samples to improve model performance can be costly and time-consuming.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method to perform material classification of imagery. The method includes obtaining, by a computing system, an input image. The method includes adding, by the computing system, a set of added noise to the input image to generate a noised image. The method includes processing, by the computing system, the noised image with a denoising diffusion model conditioned with a first set of conditioning text to generate a first denoising output, wherein the first set of conditioning text describes a positive condition for a material. The method includes processing, by the computing system, the noised image with the denoising diffusion model conditioned with a second set of conditioning text to generate a second denoising output, wherein the second set of conditioning text describes a negative condition for the material. The method includes determining, by the computing system, a material score based at least in part on the first denoising output and the second denoising output.

Another example aspect of the present disclosure is directed to a computing system for generating synthetic negative image examples for a material. The computing system includes one or more processors and one or more non-transitory computer-readable media. The one or more non-transitory computer-readable media collectively store: a set of positive images that depict a material; a denoising diffusion model; and instructions that, when executed by the one or more processors, cause the computing system to perform operations. The operations include, for each positive image of the set of positive images: adding, by the computing system, a set of added noise to the positive image to generate a noised image; processing, by the computing system, the noised image with the denoising diffusion model conditioned with a set of conditioning text to generate a denoised image, wherein the set of conditioning text textually describes a negative condition for the material; and storing, by the computing system, the denoised image as a negative image example for the material.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a graphical diagram of an example technique for performing material classification on imagery according to example embodiments of the present disclosure.

FIG. 2 depicts a graphical diagram of an example technique for generative synthetic negative example images for materials according to example embodiments of the present disclosure.

FIG. 3 depicts a flow chart diagram of an example method to perform material classification of imagery according to example embodiments of the present disclosure.

FIG. 4 depicts a flow chart diagram of an example method to generate synthetic negative image examples for a material according to example embodiments of the present disclosure.

FIG. 5A depicts a block diagram of an example computing system according to example embodiments of the present disclosure.

FIG. 5B depicts a block diagram of an example computing device according to example embodiments of the present disclosure.

FIG. 5C depicts a block diagram of an example computing device according to example embodiments of the present disclosure.

Reference numerals that are repeated across plural figures are intended to identify the same features in various implementations.

### DETAILED DESCRIPTION

Example aspects of the present disclosure are directed to systems and methods that perform material classification of imagery using generative denoising diffusion models. Traditional material classification systems, which are predominantly based on discriminative models, face issues with generalization and diversity, particularly when encountering new or complex material compositions. Furthermore, these systems often function like black boxes, making it difficult to understand their decision-making processes or identify spurious correlations. The present disclosure addresses these challenges by leveraging the capabilities of diffusion models, which can provide better generalization and more transparent decision-making processes.

Specifically, the technology described herein can perform a diffusion process for images conditioned on material presence labels. At inference time, the denoising diffusion model acts as an implicit classifier by deriving material scores from its conditioned denoising errors. This approach can potentially offer more balanced performance across different material types and superior generalization to new material compositions.

Another significant challenge in developing robust material classification models is the scarcity of training data that represents a wide variety of materials under different conditions. The present disclosure addresses this issue by using the generative nature of denoising diffusion models to create a diverse set of high-quality negative example images for materials. These synthetic data examples can be used to augment the training data, improving the performance of material classification models.

More particularly, one example aspect of the present disclosure is directed to a systems and methods for performing material classification analysis of imagery. A computing system can analyze an input image that depicts one or more objects composed of one or more materials. For instance, the input image could be captured by a camera in a recycling facility or a snapshot taken for quality control in manufacturing. The computing system can obtain this image and add a set of noise to it to generate a noised image. The added noise can be random, patterned, or based on specific parameters to increase the complexity of the image.

Next, the computing system can process the noised image with a denoising diffusion model. This model can be conditioned with a first set of conditioning text that describes a positive condition for a material. For example, the conditioning text could be a simple descriptor like “material”, or a more complex description that specifies certain characteristics of the material. The result of this processing is a first denoising output.

The noised image can also be processed with the denoising diffusion model conditioned with a second set of conditioning text. In this case, the conditioning text describes a negative condition for the material, indicating the absence, misclassification, or other negative condition of the material. The result of this processing is a second denoising output.

The present disclosure also includes determining a material score based on the first and second denoising outputs. This score can be useful in differentiating between images containing the material and those that do not. For example, a high material score could indicate a high likelihood that the material is present in the image, while a low material score could suggest that the image does not contain the material or contains a different material, or vice versa depending on how the scoring function is structured. In one example, the system can generate a binary material classification by comparing the material score to a threshold value.

Specifically, in one example, the first denoising output can be a first set of predicted noise predicted by the denoising diffusion model to be removed from the noisy image to generate a first denoised image of the material. Similarly, the second denoising output can comprise a second set of predicted noise predicted by the denoising diffusion model to be removed from the noisy image to generate a second denoised image representing a negative example for the material. The material score can be based on (e.g., a difference between) a first denoising error generated by application of a loss function to the set of added noise and the first set of predicted noise and a second denoising error generated by application of a loss function to the set of added noise and the second set of predicted noise.

In another example, the first denoising output can be the first denoised image of the material generated by the denoising diffusion model. Similarly, the second denoising output can be the second denoised image generated by the model and representing a negative example for the material. The material score can be based on (e.g., a difference between) a first reconstruction error generated by application of a loss function to the input image and the first denoised image and a second reconstruction error generated by application of a loss function to the input image and the second denoised image.

In some implementations, the denoising diffusion model can operate over a plurality of time steps. The material score can be aggregately computed over multiple of these time steps. For example, the material score can be aggregately computed over a middle subset of these time steps. This feature allows for a more nuanced analysis of the image and can increase the accuracy of the material score.

In some implementations, the computing system can also provide one or both of the first denoising output and the second denoising output for display to a user. This feature can help a user (e.g., a system operator or administrator) interpret the material score and understand why the system generated the material score that it did.

In some implementations, prior to use at inference as described above, the denoising diffusion model can be trained on a training dataset that includes images of various materials. This dataset can include a variety of images, such as photographs of materials taken under different conditions, with varying angles and lighting. Training the model on a diverse dataset can improve its ability to accurately analyze and classify material types within images.

Finally, the present disclosure can include actions based on the material score. For instance, the system could be used as part of a sorting system in recycling facilities to sort various materials. If the material score suggests that the material is present, the system could direct the item to the appropriate recycling stream; if the score suggests that the material is absent or misclassified, the system could direct the item to another stream or for further inspection.

Another example aspect of present disclosure is directed to systems and methods for generating synthetic negative image examples for material classification. This system can begin by obtaining a set of positive images for a material. The positive images can depict the material in different settings, such as recycling facilities, manufacturing environments, or natural scenes. These images can be collected from various sources, including digital cameras, industrial sensors, or online databases.

The computing system can add a set of noise to each positive image to generate a noised image. This noise can be random, structured, or based on specific parameters to reflect different conditions under which materials might be imaged. For example, a slight amount of noise can be introduced to simulate minor image perturbations, while a substantial amount of noise can simulate more challenging imaging conditions.

The computing system can process each noised image with a denoising diffusion model to generate a denoised image. The model can be conditioned with a set of conditioning text that textually describes a negative condition for the material, indicating an absence or other negative or inapposite state of the material. This conditioning text can encompass various descriptions, such as a material being contaminated, degraded, or incorrectly identified or such as a different or opposite material being present.

The computing system can then store the denoised image as a synthetic negative image example for the material. This storage can occur in the computer-readable media, and the image can be retained in various formats, such as JPEG, PNG, or TIFF. The stored image can be accessed later for several purposes, for instance, to augment training data for discriminative models or to evaluate material classification systems.

Thus, in some instances, the computing system can train a discriminative model using the synthetic negative image examples. This model can be employed to differentiate between materials and improve the accuracy of material classification tasks. The model can be trained using diverse machine learning approaches, including supervised learning, unsupervised learning, or semi-supervised learning. For example, a supervised learning approach can be applied to teach the model to predict a negative label when provided with the negative image example.

The present disclosure can be applied in numerous contexts. For instance, it can be used in automated sorting systems in recycling facilities to enhance the accuracy of material separation. It can also be utilized in manufacturing for quality control to ensure materials meet specified standards. Moreover, it can be applied in environmental monitoring to identify and categorize materials found in various ecosystems. More generally, the proposed systems can be used to determine whether or not a particular material is present in an image.

The technology described in the present disclosure provides several technical effects and advantages. As one example, the technology employs a generative diffusion model to develop an ‘implicit classifier’ for material classification. This technical solution is innovative as it departs from conventional discriminative model-based approaches, which may struggle with the diversity and variability of materials. One benefit of this modeling approach lies in its improved generalization capabilities when encountering new material types or compositions. This is a technical effect as it bolsters the system's capability to accurately classify materials, thereby enhancing the efficacy and reliability of material classification systems.

As another example, the technology addresses the challenge of limited training data availability in material classification by utilizing the generative nature of diffusion models to create synthetic negative examples for materials. This technical solution employs a machine learning model to generate novel data that can be used to train other models. The benefits of this solution are multiple. First, it mitigates the need for resource-intensive collection of varied material samples in different conditions. Second, it boosts the performance of material classification models by providing a richer and more diverse training dataset. Both are technical effects as they improve the efficiency and performance of material classification systems.

Another technical benefit is the use of a denoising diffusion model that operates over multiple time steps and the computation of the material score across multiple of these steps. This technical solution enables a more sophisticated analysis of the denoising process, which, in turn, enhances the accuracy of the material score. This is a technical effect as it increases the precision of the material classification system, leading to a reduction in both false positives and false negatives.

With reference now to the Figures, example embodiments of the present disclosure will be discussed in further detail.

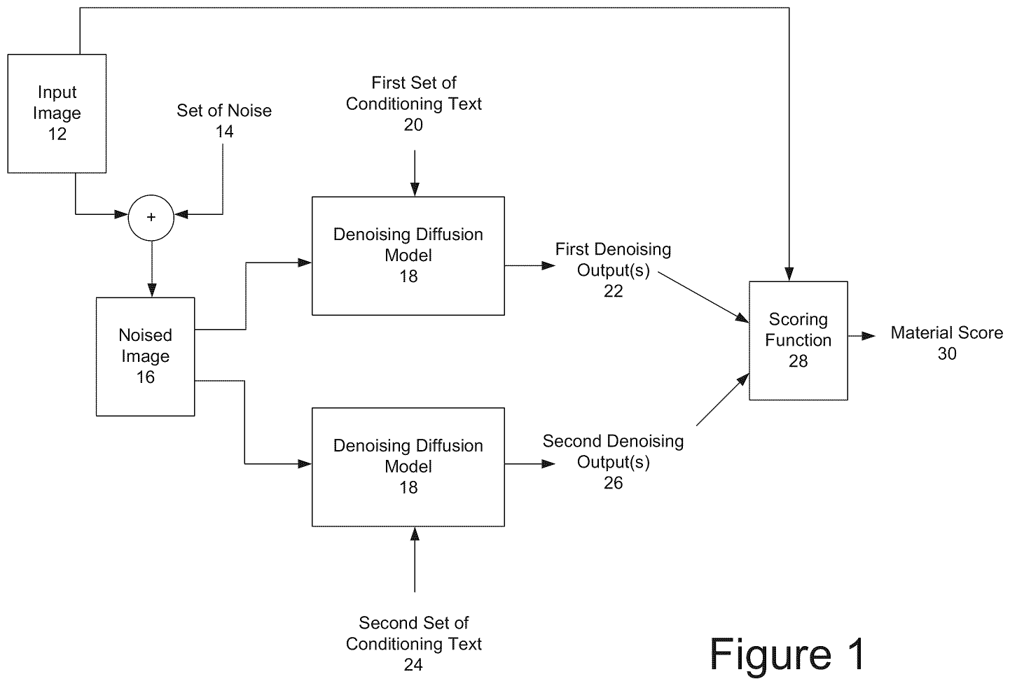

FIG. 1 provides a visual representation of an example method for material classification of imagery according to example implementations of the present disclosure. This figure serves as a schematic diagram illustrating the steps included in processing an input image 12 to determine the presence of a specific material through the application of a denoising diffusion model and the subsequent generation of a material score. As an example, the input image 12 could be a high-resolution photograph captured by an industrial-grade camera in a waste sorting facility to identify different types of plastics.

Before discussing the specific examples shown in FIG. 1, a more general description of diffusion models is now provided. Denote the data distribution of natural images as q(x₀), where x₀ is a clean image sample. The forward diffusion process gradually adds Gaussian noises to the image according to a schedule β₁, . . . , β_{T}, with T being the total number of steps:

$$q ( {x}_{t} \vert {x}_{t} - 1 ) := 𝒩 ( {x}_{t} ; \sqrt{1 - {β}_{t}} {x}_{t} - 1 , {β}_{t} I ) . \qquad ( 1 )$$

Note that given the schedule β₁, . . . , β_{T}, we can sample xₜ at arbitrary timestep t in closed form:

$$\begin{matrix}q ( {x}_{t} \vert {x}_{0} ) = 𝒩 ( {x}_{t} ; \sqrt{{\overline{α}}_{t}} {x}_{0} , ( 1 - {\overline{α}}_{t} ) I ) , \\ with {\overline{α}}_{t} := {\prod }_{i = 0}^{t} ( 1 - {β}_{i} ) .\end{matrix} \qquad ( 2 )$$

Diffusion models learn to approximate the data distribution of natural images by learning a reverse process, which gradually denoises Gaussian noises into images:

$${p}_{θ} ( {x}_{t} - 1 \vert {x}_{t} ) := 𝒩 ( {x}_{t - 1} ; {μ}_{θ} ( {x}_{t} ) , {\sum }_{θ} ( {x}_{t} ) ) , \qquad ( 3 )$$

where θ is the learnable parameters of the diffusion model.

During training, diffusion models are usually trained to predict the added noise at timestep t, \tilde{ϵ}_{θ}(x+, t), which denotes the output of a DM given a noise input xₜ and timestep t.

By randomly sampling a Gaussian noise ϵ˜ [symbol] (0, I) we can get a closed-form presentation of the noise added at timestep t according to Eq. (2). Then, the noise prediction loss used for training can be expressed as

$$L ( x , t , ϵ ) = {‖ {\tilde{ϵ}}_{θ} ( {x}_{t} , t ) - ϵ ‖}^{2} . \qquad ( 4 )$$

In some implementations, diffusion models can be conditional diffusion models. While in previous formulas, the output of a diffusion model is only conditioned on the timestep and image input. Conditional diffusion models can take in another variable c as the condition in the reverse process: p_{θ}(xₜ−1|xₜ, c). The condition variable can be in different forms depending on the generation task. For example, text-to-image generation, c is the text embedding of the prompt; image-to-image tasks such as super-resolution, c can be the low-resolution image input, and in class-conditioned models, c is the class index.

In addition, conditional DMs trained with random dropout on c (i.e. null condition) enable classifier-free guidance during sampling, which provides a signal similar to the gradient of an implicit classifier that guides the DM's sampling process. While classifier guidance needs an external classifier for guidance, classifier-free guidance only requires sampling from the same DM twice (with and without conditions) and taking the linear combination of the two score estimates as the final estimate.

Referring now to FIG. 1, the initial step in the process depicted in FIG. 1 includes obtaining the input image 12, which can be any digital representation of a scene or object where material classification is desired. This input image 12 serves as the starting point for the classification technique. For instance, the input image could be pre-processed using image enhancement techniques to improve the visibility of material features before noise is added.

Subsequently, the method includes adding a set of added noise 14 to the input image 12. This noise addition process results in a noised image 16, which is an altered version of the original input image with an overlay of noise. The noise can be artificially introduced using a Gaussian distribution or other statistical models to simulate various distortions that might occur in real-world scenarios, thereby enhancing the robustness of the model.

The noised image 16 is then processed by a denoising diffusion model 18. This model is a sophisticated machine learning architecture that iteratively refines the image by reversing the noise addition process, as described above. The model 18 is conditioned with a first set of conditioning text 20, which describes a positive condition for a material. The conditioning text 20 serves as a guide for the model to focus on specific attributes or features relevant to the material in question. As an example, the first set of conditioning text 22 might include metadata related to the material's reflective properties to aid the denoising process or may simply include the word “material” (where “material” is a representative of the material name, e.g., “plastic”, “aluminum”, etc.).

The output of this processing step is a first denoising output 22. In some cases, the first denoising output 22 can be a prediction of the noise to be removed from the noised image 16 to produce a denoised image, e.g., which may be denoted as \tilde{ϵ}_{θ}(xₜ, t), as described above. In other cases, the first denoising output 22 can be the denoised image itself, for example, which may generally be created by removing the predicted noise from the noised input.

In parallel, the noised image 16 is also processed with the same denoising diffusion model 18 but conditioned with a second set of conditioning text 24. This text describes a negative condition for the material, effectively instructing the model to generate output as if the material were absent or misclassified. For example, the second set of conditioning text could be designed to prompt the model to focus on common contaminants or adjoining materials that might be mistaken for the target material. As another example, the first set of conditioning text 22 might include simply include the words “not material” (where “material” is a representative of the material name, e.g., “plastic”, “aluminum”, etc.) or may include the name of a different material that is thought to be the opposite of the material for which classification is sought.

The result of this step is a second denoising output 26, which is analogous to the first denoising output but represents a negative or opposite condition. As an example, in some cases, the second denoising output 26 can be a prediction of the noise to be removed from the noised image 16 to produce a denoised image. In other cases, the second denoising output 26 can be the denoised image itself.

The next phase includes evaluating a scoring function 28 to determine a material score 30. This function assesses the first denoising output 22 and the second denoising output 26, comparing them in a manner that generates the material score 30 that quantifies the likelihood of material presence. The material score 30 provides a basis for classifying the material within the input image 12. For instance, the material score 30 could be integrated with a control system in an automated sorting line to trigger mechanical separators that sort materials based on the computed material score 30.

In some implementations, the first and second denoising outputs consist of predicted sets of noise or reconstructed images, and the material score 30 is based on errors calculated by applying the scoring function 28 to these outputs.

In particular, in some implementations, the first denoising output 22 and the second denoising output 26 can be predictions of the noise to be removed from the noised image 16 to produce respective denoised image. In some of such implementations, the scoring function 28 may have the following form:

$$s ( x ) = {𝒢}_{T} ( L ( ϵ , {\tilde{ϵ}}_{θ} ( x , t , {c}_{positive} ) ) - L ( ϵ , {\tilde{ϵ}}_{θ} ( x , t , {c}_{negative} ) ) ) \qquad ( 5 )$$

In Eq. (5), L is a loss function (e.g., mean square error) that measures the model's denoising error with its prediction being Fe and the actual noise being e. G is an aggregation function that gathers the errors from a total of T time steps.

In other implementations, the first denoising output 22 and the second denoising output 26 can be the actual denoised images. In some of such implementations, the scoring function 28 may have the following form:

$${s}_{recon} ( x ) = L ( x , {p}_{θ} ( {x}_{0} \vert {x}_{T} , {c}_{positive} ) ) - L ( x , {p}_{θ} ( {x}_{0} \vert {x}_{T} , {c}_{negative} ) ) , \qquad ( 6 )$$

where L is some loss function (e.g., the mean square error loss) that measures the reconstruction error between the original input x and the reconstructed or denoised image p_{θ}(x₀|x_{T}, c) from the noisy input x_{T}.

In yet further examples, the scoring function 28 can be a step-wise denoising error (“t-error”). This scoring function measures the de-noising error at timestep t by adding a single-step noise on the noisy image xₜ and performing a single-step denoise:

$${L}_{t - error} ( x , t , c ) = {‖ {p}_{θ} ( {x}_{t} \vert q ( {x}_{t} + 1 \vert {x}_{t} c ) , c ) - {x}_{t} ‖}^{2} \qquad ( 7 )$$

where q(xₜ+1|xₜ,) is the one-step noised sample at timestep t. The material scoring function 28 based on “t-error” can then be defined as:

$${s}_{t - error} ( x ) = {L}_{t - error} ( x , t , {c}_{positive} ) - {L}_{t - error} ( x , t , {c}_{negative} ) . \qquad ( 8 )$$

According to another aspect, the denoising diffusion model 18 may operate over multiple time steps, and in certain implementations, the material score 30 is computed aggregately over these steps. This temporal aspect allows for a more dynamic and nuanced analysis, potentially increasing the accuracy of the classification. For example, in some implementations, the material score 30 is computed aggregately over all of the T time steps, e.g., as shown in equation (5). In other implementations, the material score 30 can be computed aggregately over some subset of the T time steps. For example, the material score 30 can be computed aggregately over a middle range of the time steps. As one example, the denoising process can occur for 1000 time steps and the material score 30 can be computed aggregately over time steps t∈[350,650]. Other ranges can be used as well.

Referring still to FIG. 1, the denoising diffusion model 18 used in this process can be trained on a diverse dataset that includes images of various materials. A diverse dataset can provide the model with a broad understanding of material characteristics and improve the classification accuracy of the model. For example, this training dataset could be augmented with synthetic images generated by the model itself, providing a wider array of material examples for the model to learn from.

In some implementations, the process shown in FIG. 1 can also include providing the denoising outputs to a user for review, thereby facilitating an interpretation of the material score 30. This step can enhance the transparency of the process and provide insights into the decision-making mechanism of the model. For instance, a user interface could display side-by-side comparisons of the denoised images and the original input to help users understand the basis for the material score 30.

The process shown in FIG. 1 can be applied to many different forms of material classification. As one example the proposed technology can be applied to the domain of anti-spoofing measures, particularly in the context of anti-spoofing systems. In such scenarios, the “material” to be classified is not a tangible raw material (e.g., “aluminum”) but instead refers the biometric characteristics of a live human being (e.g., the material can be considered to be organic human tissue such as living epidermal tissue). The “not material” condition, conversely, can corresponds to a spoof attempt, which may include the use of masks, photographs, videos, or other artificial replicas designed to mimic the biometric features (e.g., epidermal tissue) of a genuine user.

In an illustrative application of this technology to anti-spoofing, a security system equipped with a camera can capture an image of an individual attempting to gain physical or virtual access to a physical or virtual resource. This input image serves as the basis for determining whether the subject is a live human or a spoof. The image is processed by adding a set of noise.

Once the noised image is generated, it is fed into the denoising diffusion model conditioned with the first set of conditioning text that describes the positive condition, i.e., the presence of a live human (e.g., “live”). The model processes the image to predict the noise that needs to be removed to restore the image to what it would look like if it depicted a real human face. This results in a first denoising output that is indicative of live human traits.

Simultaneously, the same noised image is processed by the denoising diffusion model conditioned with the second set of conditioning text that describes the negative condition, i.e., a spoof attempt (e.g., “spoof”). This model's task is to predict how the image should appear if it were a spoof, resulting in a second denoising output. The differences between the first and second denoising outputs can form the basis for the subsequent determination of a material score that reflects the likelihood of the image being that of a live human versus a spoof.

The material score is then evaluated, potentially using a scoring function that compares the two denoising outputs. In anti-spoofing applications, this score can inform the security system whether to grant or deny access. For example, a high material score indicating a live human could trigger the unlocking of a secure door, while a low score suggestive of a spoof could activate an alarm or prompt further verification measures.

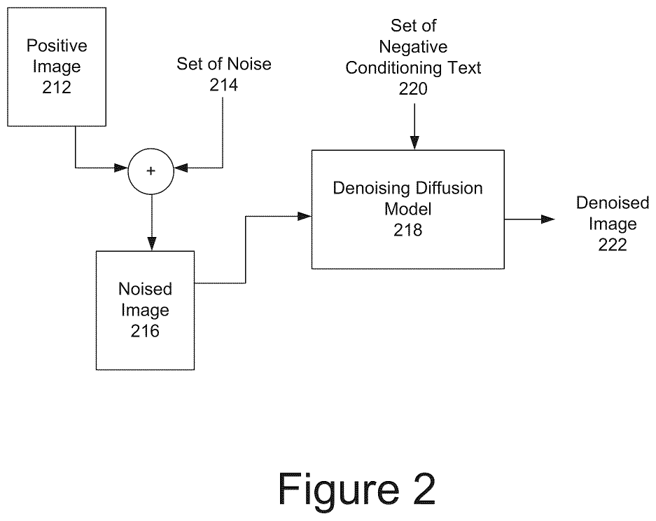

FIG. 2 illustrates a graphical diagram of an example technique for generating synthetic negative example images for materials as per example embodiments of the present disclosure. This technique is particularly useful for enhancing the robustness and generalization of material classification models by providing them with examples of what does not constitute a certain material, thereby aiding in the reduction of false positives during classification tasks.

The process begins with a positive image 212 that accurately depicts a material of interest. This positive image 212 serves as the authentic representation of the material and is the input from which synthetic negative examples are created. As an example, the positive image could be a high-resolution photograph of a metal piece, which a recycling sorting system needs to distinguish from other recyclable materials.

A set of added noise 214 is then introduced to this positive image 212 to create a noised image 216. Subsequently, the noised image 216 is processed with a denoising diffusion model 218. This advanced generative model is capable of iteratively refining the image by removing noise. However, in this instance, the model 218 is conditioned with a set of conditioning text 220 that is designed to describe a negative condition for the material. For example, the conditioning text might specify that the material is not present or has been contaminated, prompting the model to generate an image that reflects the absence or alteration of the material.

The output of the denoising diffusion model's processing is a denoised image 222, which, due to the negative conditioning, serves as a synthetic negative example of the material. This denoised image 222 is then stored and can be utilized as part of a training dataset for a discriminative model. As an example, the denoised image could be stored in a database with metadata tagging it as a negative example, which can be retrieved during the training process of classification models.

In some implementations, the technique includes an additional step of training a discriminative model using the synthetic negative image example. This discriminative model can be any machine learning model that benefits from having examples of both what to identify and what to reject. For instance, the discriminative model could be a convolutional neural network that is trained to sort materials based on textural and color features, and the inclusion of negative examples helps in fine-tuning its decision boundaries.

The technique depicted in FIG. 2 is particularly advantageous for situations where collecting real negative examples is challenging or impractical. By generating synthetic negatives, the model can learn from a more comprehensive range of examples without the need for extensive data collection efforts. As an example, this approach could be used to create negative examples of rare materials or conditions that are not commonly encountered but are advantageous for the model to recognize.

The process shown in FIG. 2 can be applied to a number of different material classification contexts. As one example, the process can be used to generate negative examples (e.g., spoof samples) for anti-spoofing systems. In particular, in the context of anti-spoofing systems, where the identification of live persons is a signal used to distinguish between legitimate users and fraudulent attempts, the application of the technique depicted in FIG. 2 becomes particularly valuable.

Consider a scenario where the positive image depicts a live person, captured by a camera at an access control point. To enhance the system's ability to detect and prevent spoofing attempts, where an imposter might use a photograph, video, mask, or other forms of replicas to mimic a live person, the negative conditioning text is designed to describe or indicate a “spoof” of a live person. This text guides the denoising diffusion model in processing the noised image to emphasize features that are typical of spoofing attempts, such as unnatural lighting, lack of typical facial movements, or textural differences that would not be present in an image of a live person.

The denoised image that is generated therefore represents a synthetic spoof image example, which is an artificial creation that the biometric system can use to learn the characteristics of various spoofing techniques. By incorporating this synthetic spoof image example into the training dataset, the anti-spoofing system can be trained to be more discerning, improving its ability to differentiate between genuine live persons and sophisticated spoofs. For example, the anti-spoofing system can use these negative examples to recognize the subtle differences in texture between real skin and a mask or to detect the absence of micro-expressions typically present in a live person.

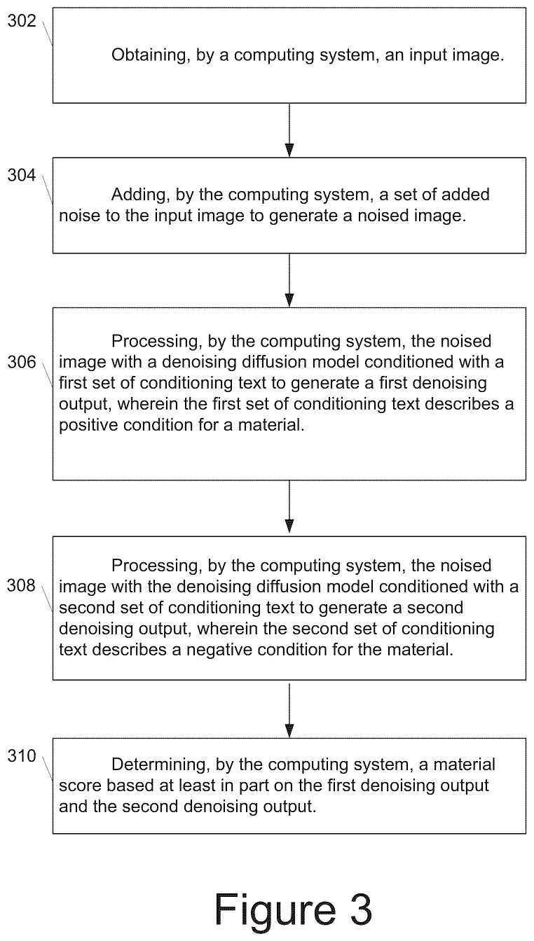

Referring now to FIG. 3, a flow chart diagram illustrates an example method for performing material classification of imagery, as executed by a computing system according to example embodiments of the present disclosure. The method begins with operation 302, where the computing system obtains an input image. The input image can be any digital representation of a scene or object where material classification is desired, such as a photograph captured by a camera in a recycling facility or a snapshot taken for quality control in manufacturing.

Following the acquisition of the input image, the computing system proceeds to operation 304, where it adds a set of added noise to the input image to generate a noised image. This added noise can be random or patterned.

Operation 306 includes the computing system processing the noised image with a denoising diffusion model conditioned with a first set of conditioning text to generate a first denoising output. The first set of conditioning text is designed to describe a positive condition for a material, such as the presence or desired traits of the material in the image. The first denoising output can be a prediction of the noise to be removed from the noised image or the denoised image itself, depending on the implementation.

Operation 308 includes the processing of the noised image with the denoising diffusion model conditioned with a second set of conditioning text to generate a second denoising output. Here, the second set of conditioning text describes a negative condition for the material, indicating its absence, misclassification, or other negative attributes. As with the first denoising output, the second denoising output can be a prediction of the noise to be removed or the denoised image itself.

At operation 310, the computing system determines a material score based at least in part on the first denoising output and the second denoising output. This material score is a quantitative measure that reflects the likelihood of the material's presence or absence in the input image, thereby facilitating the classification of the material. The score can be computed using various loss functions and aggregation methods over multiple time steps to enhance accuracy.

The method depicted in FIG. 3 can be applied in various contexts, such as recycling, manufacturing, and content-based image retrieval, to improve the reliability and efficiency of material classification systems. The use of a denoising diffusion model conditioned with descriptive text allows for a more nuanced and transparent decision-making process, addressing the technical challenges of traditional discriminative models.

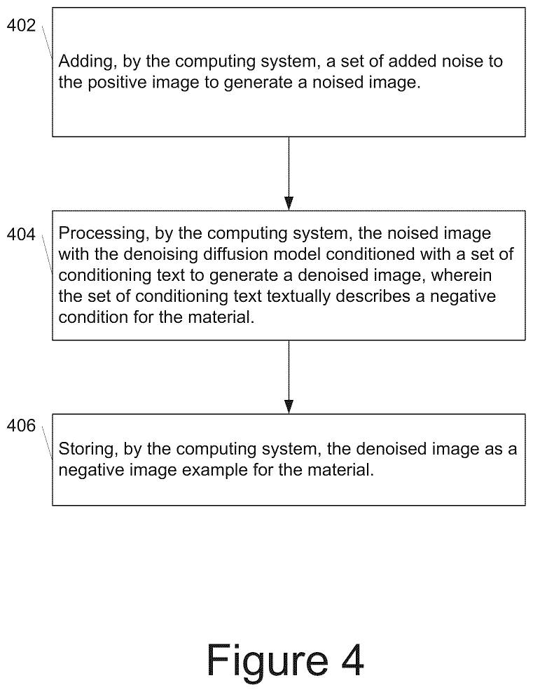

Referring now to FIG. 4, a flow chart diagram illustrates an example method 400 for generating synthetic negative image examples for a material, as executed by a computing system in accordance with example embodiments of the present disclosure. The method 400 provides a systematic approach to creating high-quality synthetic images that can be used to augment training datasets for material classification models, particularly enhancing the models' ability to accurately identify materials by learning from examples of what the material is not.

Operation 402 includes adding, by the computing system, a set of added noise to a positive image to generate a noised image. The positive image is an authentic representation of a material that the model aims to classify correctly. By introducing noise into the positive image, example implementations can simulate the conditions under which the denoising diffusion model must operate to discern the material's characteristics. This added noise can vary in intensity and pattern.

At operation 404, the computing system processes the noised image with the denoising diffusion model conditioned with a set of conditioning text to generate a denoised image. The set of conditioning text is crafted to textually describe a negative condition for the material, such as the absence of the material or its contamination. This negative conditioning guides the denoising diffusion model to focus on attributes that are opposite or distinct from the material's positive characteristics, resulting in a denoised image that serves as a synthetic negative example.

Lastly, operation 406 includes storing, by the computing system, the denoised image as a negative image example for the material. The storage of this synthetic negative example is beneficial for the subsequent use in training discriminative models. These models can leverage the synthetic negative examples to improve their classification accuracy by learning to distinguish between actual instances of the material and conditions where the material is not present.

The method 400 provides a technical solution to the problem of limited training data for material classification models by generating synthetic negative examples that enhance the models' generalization capabilities and performance.

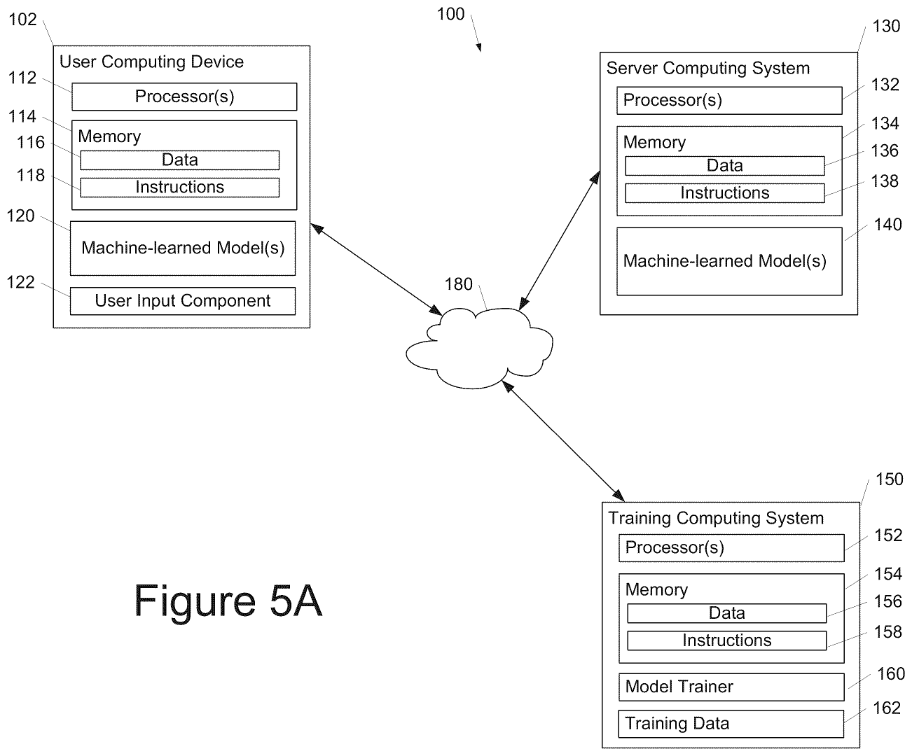

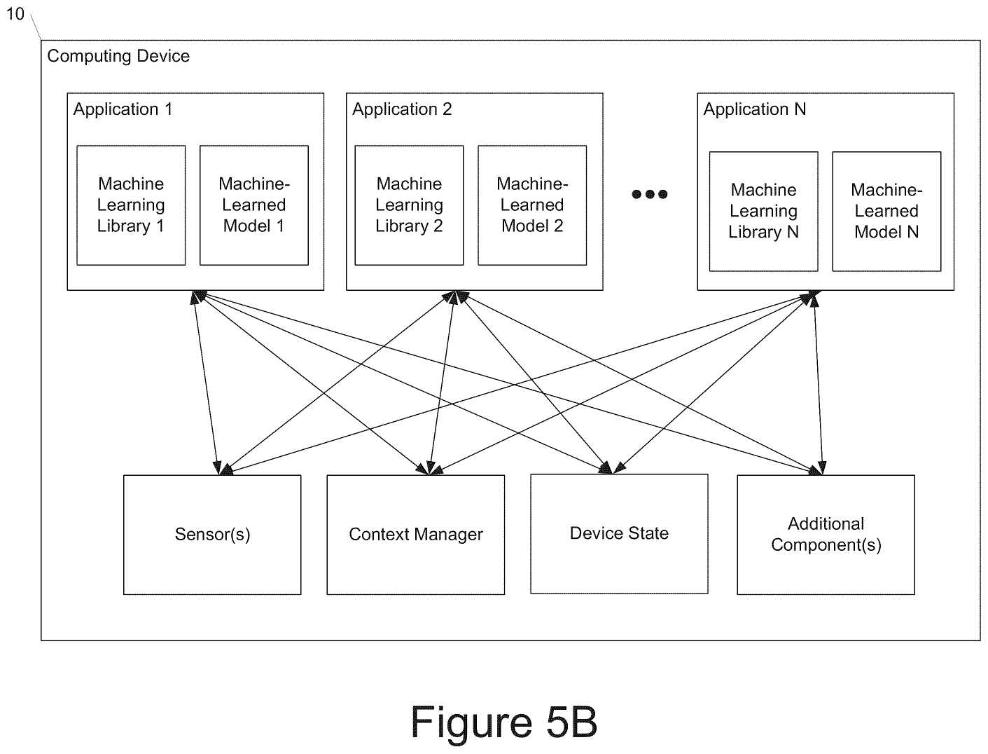

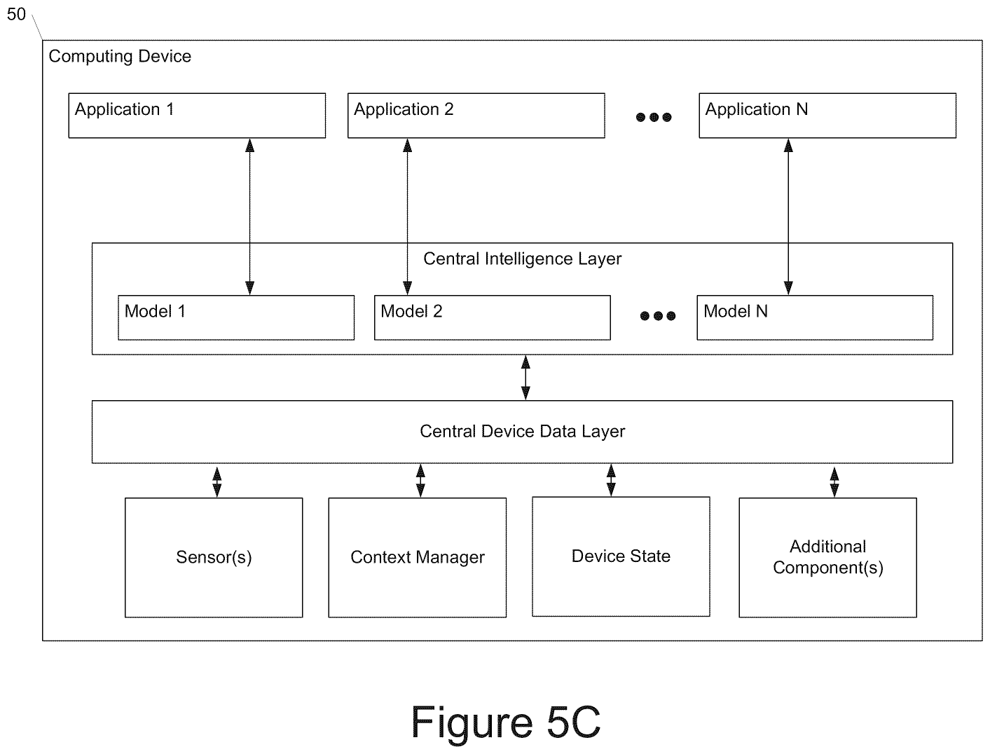

FIG. 5A presents a block diagram of an exemplary computing system 100 that executes material classification and generative modeling techniques as described in the present disclosure. The system 100 encompasses a user computing device 102, a server computing system 130, and a training computing system 150, all interconnected via a network 180.

The user computing device 102 can represent various types of computing devices, such as personal computing devices (e.g., laptops or desktops), mobile computing devices (e.g., smartphones or tablets), gaming consoles or controllers, wearable computing devices, embedded computing devices, or other computing devices.

Equipped with one or more processors 112 and memory 114, the user computing device 102 can execute computational tasks. The processors 112 can include a range of processing devices such as processor cores, microprocessors, ASICs, FPGAs, controllers, microcontrollers, and the like, either singly or in combination. Memory 114 can consist of various non-transitory computer-readable storage media including but not limited to RAM, ROM, EEPROM, EPROM, flash memory devices, magnetic disks, and combinations thereof, storing data 116 and instructions 118 that, when executed by processors 112, enable the user computing device 102 to perform material classification operations.

The user computing device 102 can house and/or access one or more generative and/or classification models 120, which can include diverse machine-learned models such as neural networks (e.g., deep neural networks, recurrent neural networks, convolutional neural networks) or other types of machine-learned models, possibly incorporating non-linear and linear models. Some models can utilize attention mechanisms such as self-attention, including multi-headed self-attention models like transformer models.

In certain embodiments, the user computing device 102 can receive one or more of these models 120 from the server computing system 130 via network 180, which are then stored in memory 114 and utilized by processors 112. The user computing device 102 can also run multiple parallel instances of a model 120 to concurrently perform material classification tasks on different data sets.

More particularly, the generative and classification models 120 can be applied to enhance the accuracy and efficiency of material classification systems by generating synthetic negative examples and by discriminating between various material types in imagery.

Alternatively, or in addition, server computing system 130 can implement one or more models 140 that operate in a server-client relationship with the user computing device 102. For instance, models 140 can form part of a web-based service for material classification and generative modeling tasks, with the option for models 120 to be executed on the user computing device 102 and/or models 140 on the server computing system 130.

The user computing device 102 can also include user input components 122 for capturing user interactions. These can range from touch-sensitive components like touchscreens or touchpads that detect inputs from fingers or styluses and can be used to operate a virtual keyboard, to other input means such as microphones or physical keyboards.

The server computing system 130, similar to the user computing device 102, can include one or more processors 132 and memory 134. These processors 132 can be analogous in variety and function to processors 112, and memory 134 can store various forms of data 136 and instructions 138 which, when executed by processors 132, prompt the server computing system 130 to perform specified operations.

The server computing system 130 can be realized through one or more server computing devices and can operate using sequential, parallel, or a combination of computing architectures when multiple server devices are included.

As previously mentioned, server computing system 130 can store or incorporate one or more models 140, which can include various machine-learned models. These models can be neural networks or other multi-layer non-linear models, potentially utilizing self-attention mechanisms or multi-headed self-attention models such as transformer models.

One example type of machine learning model (e.g., model 120 and/or 140) is a denoising diffusion model (or “diffusion model”). A denoising diffusion model can be defined as a type of generative model that learns to progressively remove noise from a set of input data to generate new data samples. A comprehensive discussion of diffusion models is provided by Yang L., Zhang Z., Song Y., Hong S., Xu R., Zhao Y., Zhang W., Cui B., and Yang M., Diffusion Models: A Comprehensive Survey of Methods and Applications, arXiv: 2209.00796 [cs.LG]. See also, Sohl-Dickstein, J., Weiss, E., Maheswaranathan, N., & Ganguli, S. (2015). Deep Unsupervised Learning using Nonequilibrium Thermodynamics. In International Conference on Machine Learning (ICML); Song, Y., & Ermon, S. (2019). Generative Modeling by Estimating Gradients of the Data Distribution. In Advances in Neural Information Processing Systems (NeurIPS); Ho, J., Jain, A., & Abbeel, P. (2020). Denoising Diffusion Probabilistic Models. In Advances in Neural Information Processing Systems (NeurIPS); and Song, Y., Sohl-Dickstein, J., Kingma, D. P., Kumar, A., Ermon, S., & Poole, B. (2020). Score-Based Generative Modeling through Stochastic Differential Equations. In International Conference on Learning Representations (ICLR).

More particularly, in some implementations, the diffusion process of a denoising diffusion model can include both forward and reverse diffusion phases. The forward diffusion phase can include gradually adding noise (e.g., Gaussian noise) to data over a series of time steps. This transformation can lead to the data eventually resembling pure noise. For example, in the context of image processing, an initially clear image can incrementally receive noise until it is indistinguishable from random noise. In some implementations, this step-by-step addition of noise can be parameterized by a variance schedule that controls the noise level at each step.

Conversely, the reverse diffusion phase can include systematically removing the noise added during the forward diffusion to reconstruct the original data sample or to generate new data samples. This phase can use a trained neural network model to predict the noise that was added (or conversely, that should be removed) at each step and subtract it from the noisy data. For instance, starting from a purely noisy image, the model can iteratively denoise the image, progressively restoring details until a clear image is obtained.

This process of reverse diffusion can be guided by learning from a set of training data, where the model learns the optimal way to remove noise and recover data. The ability to reverse the noise addition effectively allows the generation of new data samples that are similar to the training data and/or modified according to specified conditions. In particular, in the learned reverse diffusion process, the diffusion model can be used to generate new samples that can either replicate the original or produce variations based on the learned data distribution.

In some implementations, denoising diffusion models can operate in either pixel space or latent space, each offering distinct advantages depending on the application requirements. Operating in pixel space means that the model directly manipulates and generates data in its original form, such as raw pixel values for images. For example, when generating images, the diffusion process can add or remove noise directly at the pixel level, allowing the model to learn and reproduce fine-grained details that are visible in the pixel data.

Alternatively, operating in latent space can include transforming the data into a compressed, abstract representation before applying the diffusion process. This can be beneficial for handling high-dimensional data or for improving the computational efficiency of the model. For instance, an image can be encoded into a lower-dimensional latent representation using an encoder network, and the diffusion process can then be applied in this latent space. The denoised latent representation can subsequently be decoded back into pixel space to produce the final output image. This approach can reduce the computational load during the training and sampling phases and can sometimes help in capturing higher-level abstract features of the data that are not immediately apparent in the pixel space.

In some implementations, denoising diffusion models can utilize probability distributions to manage the transformation of data throughout the diffusion process. As one example, Gaussian distributions can be employed in the forward diffusion phase, where noise added to the data is typically modeled as Gaussian. This method can be beneficial for applications like image processing or audio synthesis, where the gradual addition of Gaussian noise helps in creating a smooth transition from original data to a noise-dominated state. However, the model can also be designed to use other types of noise distributions as part of its stochastic process.

In the reverse phase, learned transition distributions can guide the denoising steps. Specifically, a parameterized model (e.g., neural network) can be used to predict the noise to be removed at each step of the reverse phase.

Model parameters can refer to parameter values within the denoising diffusion model that can be learned from training data to optimize the performance of the denoising diffusion model. These parameters can include weights of the neural networks used to predict noise in the reverse diffusion process, as well as parameters defining the noise schedule in the forward process.

The architecture of an example denoising diffusion model can include one or more neural networks. The neural networks can be trained to parameterize the transition kernels in the reverse Markov chain. As examples, the architecture of a denoising diffusion model can incorporate various types of neural networks, such as Convolutional Neural Networks (CNNs) or Recurrent Neural Networks (RNNs).

As a specific example, in some implementations, the neural network architecture can take the form of a U-Net. The U-Net architecture is characterized by its U-shaped structure, which includes a contracting path and an expansive path. The contracting path follows the typical architecture of a convolutional network, including repeated application of convolutions, followed by pooling operations that reduce the spatial dimensions of the feature maps. The expansive path of the U-Net, on the other hand, can include a series of up-convolutions and concatenations with high-resolution features from the contracting path. This can be achieved through skip connections that directly connect corresponding layers in the contracting path to layers in the expansive path.

More generally, the neural network architecture in denoising diffusion models can include multiple layers that can include various types of activation functions. These functions introduce non-linearities that enable the network to capture and learn complex data patterns effectively, although the specific choices of layers and activations can vary based on the model design and application requirements.

Additionally, the architecture can include special components like residual blocks and attention mechanisms, which can enhance the model's performance. Residual blocks can help in training deeper networks by allowing gradients to flow through the network more effectively. Attention mechanisms can provide a means for the model to focus on specific parts of the input data, which is advantageous for applications such as language translation or detailed image synthesis, where contextual understanding significantly impacts the quality of the output. These components are configurable and can be integrated into the neural network architecture to address specific challenges posed by the complexity of the data and the requirements of the generative task.

In some implementations, the training process of a denoising diffusion model can be oriented towards specific learning objectives. These objectives can include minimizing the difference between the original data and the data reconstructed after the reverse diffusion process. Specifically, in some implementations, an objective can include minimizing the Kullback-Leibler divergence between the joint distributions of the forward and reverse Markov chains to ensure that the reverse process effectively reconstructs or generates data that closely matches the training data. As another example, in image processing applications, the objective may be to minimize the pixel-wise mean squared error between the original and reconstructed images. Additionally, the model can be trained to optimize the likelihood of the data given the model, which can enhance the model's ability to generate new samples that are indistinguishable from real data.

Various strategies can be used to perform the training process for diffusion models. Gradient descent algorithms, such as stochastic gradient descent (SGD) or Adam, can be utilized to update the model's parameters. Moreover, learning rate schedules can be implemented to adjust the learning rate during training, which can help in stabilizing the training process and improving convergence. For instance, a learning rate that decreases gradually as training progresses can lead to more stable and reliable model performance.

Various loss functions can be used guide the training of denoising diffusion models. Example loss functions include the mean squared error (MSE) for regression tasks or cross-entropy loss for classification tasks within the model. Additionally, variational lower bounds, such as the evidence lower bound (ELBO), can be used to train the model under a variational inference framework. These loss functions can help in quantifying the discrepancy between the generated samples and the real data, guiding the model to produce outputs that closely resemble the target distribution.

In some implementations, temperature sampling in denoising diffusion models can be used to control the randomness of the generation process. By adjusting the temperature parameter, one can modify the variance of the noise used in the sampling steps, which can affect the sharpness and diversity of the generated outputs. For instance, a lower temperature can result in less noisy and more precise samples, whereas a higher temperature can increase sample diversity but may also introduce more noise and reduce sample quality.

In some implementations, conditional generation can allow the generation of data samples based on specific conditions or attributes. Conditional generation in denoising diffusion models can include modifying the reverse diffusion process based on additional inputs (e.g., conditioning inputs) such as class labels or text descriptions, which guide the model to generate data samples that are more likely to meet specific conditions. This can be implemented by conditioning the model on additional inputs such as class labels, text descriptions, or other data modalities. For example, in a model trained on a dataset of images and their corresponding captions, the model can generate images that correspond to a given textual description, enabling targeted image synthesis.

More particularly, denoising diffusion models can be conditioned using various types of data to guide the generation process towards specific outcomes. One common type of conditioning data is text. For example, in generating images from descriptions, the model can use textual inputs like “a sunny beach” or “a snowy mountain” to generate corresponding images. The text can be processed using natural language processing techniques to transform it into a format that the model can utilize effectively during the generation process.

For example, one type of conditioning data can include text embeddings. Text embeddings are vector representations of text that capture semantic meanings, which can be derived from pre-trained language models such as BERT or CLIP. These embeddings can provide a denser and potentially more informative representation of text than raw text inputs. For instance, in a diffusion model tasked with generating music based on mood descriptions, embeddings of words like “joyful” or “melancholic” can guide the audio generation process to produce music that reflects these moods.

Additionally, conditioning can also include using categorical labels or tags. This approach can be particularly useful in scenarios where the data needs to conform to specific categories or classes.

Classifier-free guidance is a technique that can enhance the control over the sample generation process without the need for an additional classifier model. This can be achieved by modifying the guidance scale during the reverse diffusion process, which adjusts the influence of the learned conditional model. For instance, by increasing the guidance scale, the model can produce samples that more closely align with the specified conditions, improving the fidelity of generated samples that meet desired criteria without the computational overhead of training and integrating a separate classifier.

In some implementations, denoising diffusion models can integrate with other generative models to form hybrid models. For instance, combining a denoising diffusion model with a Generative Adversarial Network (GAN) can leverage the strengths of both models, where the diffusion model can ensure diversity and coverage of the data distribution, and the GAN can refine the sharpness and realism of the generated samples. Another example can include integration with Variational Autoencoders (VAEs) to improve the latent space representation and stability of the generation process.

Efficiency improvements are beneficial aspects of denoising diffusion models. One way to achieve this is by reducing the number of diffusion steps required to generate high-quality samples. For example, sophisticated training techniques such as curriculum learning can be employed to gradually train the model on easier tasks (fewer diffusion steps) and increase complexity (more steps) as the model's performance improves. Additionally, architectural optimizations such as implementing more efficient neural network layers or utilizing advanced activation functions can decrease computational load and improve processing speed during both training and generation phases.

Noise scheduling strategies can improve the performance of denoising diffusion models. By carefully designing the noise schedule—the variance of noise added at each diffusion step—models can achieve faster convergence and improved sample quality. For example, using a learned noise schedule, where the model itself optimizes the noise levels during training based on the data, can result in more efficient training and potentially better generation quality compared to fixed, predetermined noise schedules.

In some implementations, learned upsampling in denoising diffusion models can facilitate the generation of high-resolution outputs from lower-resolution inputs. This technique can be particularly useful in applications such as high-definition image generation or detailed audio synthesis. Learned upsampling can include additional model components that are trained to increase the resolution of generated samples through the reverse diffusion process, effectively enhancing the detail and quality of outputs without the need for externally provided high-resolution training data. In some cases, these additional learned components can be referred to as “super-resolution” models.

In some implementations, denoising diffusion models can be applied to the field of image synthesis, where they can generate high-quality, photorealistic images from a distribution of training data. For example, example models can be used to create new images of landscapes, animals, or even fictional characters by learning from a dataset composed of similar images. The model can add noise to these images and then learn to reverse this process, effectively enabling the generation of new, unique images that maintain the characteristics of the original dataset.

Denoising diffusion models can also be utilized in audio generation. They can generate clear and coherent audio clips from noisy initial data or even from scratch. For instance, in the music industry, example models can help in creating new musical compositions by learning from various genres and styles. Similarly, in speech synthesis, denoising diffusion models can generate human-like speech from text inputs, which can be particularly beneficial for virtual assistants and other AI-driven communication tools.

Other potential use cases of denoising diffusion models extend across various fields including drug discovery, where example models can help in generating molecular structures that could lead to new pharmaceuticals. Additionally, in the field of autonomous vehicles, denoising diffusion models can be used to enhance the processing of sensor data, improving the vehicle's ability to interpret and react to its environment.

In some implementations, the performance of denoising diffusion models can be evaluated using various metrics that assess the quality and diversity of generated samples. The Inception Score (IS) is one such metric that can be used; it measures how distinguishable the generated classes are and the confidence of the classification. For example, a higher Inception Score indicates that the generated images are both diverse across classes and each image is distinctly recognized by a classifier as belonging to a specific class. Another commonly used metric is the Fréchet Inception Distance (FID), which assesses the similarity between the distribution of generated samples and real samples, based on features extracted by an Inception network. A lower FID indicates that the generated samples are more similar to the real samples, suggesting higher quality of the generated data.

Both the user computing device 102 and the server computing system 130 can engage in training models 120 and/or 140 through interaction with the training computing system 150, which is networked via network 180. The training computing system 150 can be a distinct entity or integrated within the server computing system 130.

The training computing system 150 is equipped with processors 152 and memory 154, which are capable of executing a variety of computational tasks. The processors 152 and memory 154 are similar in nature to those of the user computing device 102 and server computing system 130, storing data 156 and instructions 158 that facilitate the training operations of the computing system 150.

Within the training computing system 150 resides a model trainer 160, which is responsible for training the machine-learned models 120 and/or 140 using established training techniques, such as error backpropagation. The model trainer 160 can apply various loss functions and gradient descent techniques to iteratively refine the models over numerous training iterations.

The model trainer 160 can engage in specific training approaches, such as truncated backpropagation through time, and implement generalization techniques like weight decays or dropouts to bolster the models' generalization capabilities.

Specifically, the model trainer 160 trains the generative and classification models 120 and/or 140 using a set of training data 162, which can include images of materials under various conditions, synthetic negative examples, and other relevant data to improve the models' material classification performance.

With user consent, training examples can originate from the user computing device 102, enabling the training computing system 150 to personalize model 120 based on user-specific data. This personalization process tailors the model's performance to the unique data and requirements of the user.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 5A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 5B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 5B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 5C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 5C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 5C, the central device data layer can communicate with a number of other components of the computing device, such as, for example, one or more sensors, a context manager, a device state component, and/or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method to perform material classification of imagery, the method comprising:
obtaining, by a computing system, an input image;
adding, by the computing system, a set of added noise to the input image to generate a noised image;
processing, by the computing system, the noised image with a denoising diffusion model conditioned with a first set of conditioning text to generate a first denoising output, wherein the first set of conditioning text describes a positive condition for a material;
processing, by the computing system, the noised image with the denoising diffusion model conditioned with a second set of conditioning text to generate a second denoising output, wherein the second set of conditioning text describes a negative condition for the material; and
determining, by the computing system, a material score based at least in part on the first denoising output and the second denoising output.

2. The computer-implemented method of claim 1, wherein:
the first denoising output comprises a first set of predicted noise predicted by the denoising diffusion model to be removed from the noisy image to generate a first denoised image;
the second denoising output comprises a second set of predicted noise predicted by the denoising diffusion model to be removed from the noisy image to generate a second denoised image; and
the material score is based on (1) a first denoising error generated by application of a loss function to the set of added noise and the first set of predicted noise and (2) a second denoising error generated by application of the loss function to the set of added noise and the second set of predicted noise.

3. The computer-implemented method of claim 2, wherein the loss function comprises a mean square error function.

4. The computer-implemented method of claim 1, wherein:
the first denoising output comprises a first denoised image;
the second denoising output comprises a second denoised image; and
the material score is based on (1) a first reconstruction error generated by application of a loss function to the input image and the first denoised image and (2) a second reconstruction error generated by application of the loss function to the input image and the second denoised image.

5. The computer-implemented method of claim 1, wherein determining, by the computing system, the material score comprises determining, by the computing system, a step-wise denoising error computed over a single denoising step.

6. The computer-implemented method of claim 1, wherein the denoising diffusion model operates over a plurality of time steps, and wherein determining the material score comprises aggregately computing the material score over multiple of the plurality of time steps.

7. The computer-implemented method of claim 1, wherein the denoising diffusion model operates over a plurality of time steps, and wherein determining the material score comprises aggregately computing the material score over a middle subset of the plurality of time steps.

8. The computer-implemented method of claim 1, wherein the first set of conditioning text comprises the word “material” and the second set of conditioning text comprises the words “not material”.

9. The computer-implemented method of claim 1, wherein the denoising diffusion model has been training on a training dataset that includes images of the material.

10. The computer-implemented method of claim 1, further comprising:
providing, by the computing system for display to a user, one or both of the first denoising output and the second denoising output to facilitate an interpretation of the material score.

11. A computing system for generating synthetic negative image examples for a material, the computer system comprising:
one or more processors; and
one or more non-transitory computer-readable media that collectively store:
a set of positive images that depict a material;
a denoising diffusion model; and
instructions that, when executed by the one or more processors, cause the computing system to perform operations, the operations comprising, for each positive image of the set of positive images:
adding, by the computing system, a set of added noise to the positive image to generate a noised image;
processing, by the computing system, the noised image with the denoising diffusion model conditioned with a set of conditioning text to generate a denoised image, wherein the set of conditioning text textually describes a negative condition for the material; and
storing, by the computing system, the denoised image as a negative image example for the material.

12. The computing system of claim 11, wherein the operations further comprise training a discriminative model using the synthetic spoof image example.

13. One or more non-transitory computer-readable media that collectively store computer-executable instructions, that when executed by a computing system, cause the computing system to perform operations, the operations comprising:
obtaining, by the computing system, an input image;
adding, by the computing system, a set of added noise to the input image to generate a noised image;
processing, by the computing system, the noised image with a denoising diffusion model conditioned with a first set of conditioning text to generate a first denoising output, wherein the first set of conditioning text describes a positive condition for a material;
processing, by the computing system, the noised image with the denoising diffusion model conditioned with a second set of conditioning text to generate a second denoising output, wherein the second set of conditioning text describes a negative condition for the material; and
determining, by the computing system, a material score based at least in part on the first denoising output and the second denoising output.

14. The one or more non-transitory computer-readable media of claim 13, wherein:
the first denoising output comprises a first set of predicted noise predicted by the denoising diffusion model to be removed from the noisy image to generate a first denoised image;
the second denoising output comprises a second set of predicted noise predicted by the denoising diffusion model to be removed from the noisy image to generate a second denoised image; and
the material score is based on (1) a first denoising error generated by application of a loss function to the set of added noise and the first set of predicted noise and (2) a second denoising error generated by application of the loss function to the set of added noise and the second set of predicted noise.

15. The one or more non-transitory computer-readable media of claim 14, wherein the loss function comprises a mean square error function.

16. The one or more non-transitory computer-readable media of claim 13, wherein:
the first denoising output comprises a first denoised image;
the second denoising output comprises a second denoised image; and
the material score is based on (1) a first reconstruction error generated by application of a loss function to the input image and the first denoised image and (2) a second reconstruction error generated by application of the loss function to the input image and the second denoised image.

17. The one or more non-transitory computer-readable media of claim 16, wherein the loss function comprises a mean square error function.

18. The one or more non-transitory computer-readable media of claim 13, wherein determining, by the computing system, the material score comprises determining, by the computing system, a step-wise denoising error computed over a single denoising step.

19. The one or more non-transitory computer-readable media of claim 13, wherein the denoising diffusion model operates over a plurality of time steps, and wherein determining the material score comprises aggregately computing the material score over multiple of the plurality of time steps.

20. The one or more non-transitory computer-readable media of claim 13, wherein the denoising diffusion model operates over a plurality of time steps, and wherein determining the material score comprises aggregately computing the material score over a middle subset of the plurality of time steps.
